(19) United States
(12) Patent Application Publication
(10) Pub. No.: US 2007/0201177 A1
(43) Pub. Date: Aug. 30, 2007

(54) Surge protection device disconnector

(75) Inventors: Dalibor Kladar, Calgary (CA); Mieczyslaw Bandura, Calgary (CA); Henryk J. Dabrowski, Calgary (CA); James Funke, Calgary (CA); Francois D. Martzloff, Gaithersburg, MD (US); John D. Towler, Calgary (CA); Anthony C. Mendoza, Calgary (CA); Thomas C. Hartman, Coraopolis, PA (US)

Correspondence Address: MARTIN J. MORAN, ESQ.;Eaton Electrical, Inc. Technology & Quality Center, RIDC Park West, 170 Industry Drive, Pittsburgh, PA, 15275-1032, US

(73) Assignee: EATON CORPORATION

(21) Appl. No.: 11/363,023

(22) Filed: Feb. 27, 2006

(51) Int. Cl. H02H 9/06

(52) U.S. Cl. 361/118

(57) ABSTRACT

A number of surge protection device disconnector designs provide protection to a load over a full range of fault currents provide adequate surge protection as well. The designs quench arcs that may tend to occur as a result of MOV faults, thereby protecting the surrounding components.

### FIELD OF THE INVENTION

The present invention relates to surge protection devices, and in particular to a number of surge protection device disconnector designs.

### BACKGROUND OF THE INVENTION

Electrical systems, such as electrical power distribution systems, periodically experience over-voltage conditions, such as transient over-voltage conditions, also called “surges.” Over-voltage conditions are problematic to electrical systems because they may cause damage to the loads, such as electronic devices or other hardware, that are coupled thereto. As a result, surge protection devices (SPDs) have been developed to protect the loads from over-voltages that would otherwise damage the loads. SPDs typically provide such protection by coupling various types of known transient-suppressing elements between the phase, and neutral and/or ground conductors of an electrical power distribution system.

As is known in the art, transient-suppressing elements, such as metal-oxide varistors (MOVs), silicon avalanche diodes (SADs) and gas tubes, typically assume a high impedance state under normal operating voltages. When the voltage across a transient-suppressing element exceeds a predetermined threshold rating, however, the impedance of the element drops dramatically, essentially short-circuiting the electrical conductors and “shunting” the current associated with the over-voltage through the transient-suppressing element and away from the load.

MOVs are probably the most commonly used transient-suppressing element. An MOV consists of two plates separated by an insulator, such as a metal oxide, that has a known voltage breakdown characteristic. When the voltage between the two plates reaches a certain level (the voltage breakdown level), the insulator breaks down and conducts current. MOVs, however, have operational limitations that must be taken into account when designing an SPD. Specifically, all MOVs have a maximum surge current rating that, if exceeded, may cause the MOV to fail. An MOV may also fail if subjected to repeated operation, even if the maximum transient current rating is never exceeded. The number of repeated operations necessary to cause failure is a function of the magnitude of transient current conducted by the MOV during each operation: the lower the magnitude, the greater the number of operations necessary to cause failure.

In light of these limitations, prior art SPDs have been developed that use multiple MOVs in parallel combination such that the MOVs share the total transient current. Each individual MOV in such a configuration only conducts a portion of the total transient current, making it less likely that any individual MOV will exceed its maximum transient current capacity. In addition, an SPD that uses a plurality of parallel MOVs can withstand a greater number of operations because of the lower magnitude of transient current conducted by each individual MOV. If internally fused and sorted by V/I characteristics, a parallel combination of MOVs is advantageous because the failure of any individual MOV will not cause a complete loss of SPD functionality.

When an MOV fails it initially falls into a low impedance (short) state in which it draws a large steady-state current from the electrical system. This current, if not interrupted, will drive the MOV into a thermal runaway condition, typically resulting in an explosive failure of the MOV (involving, for example, fire, toxic smoke and/or hot particles) and damage to or destruction of the SPD and surrounding components.

Generally, there have been at least two ways in which SPDs have dealt with the hazards of explosive failure. In the first, older approach, a strong metal enclosure is provided around the SPD. The problem with such enclosures is that, despite the heavy metal walls, the enclosures have been known to rupture, release toxic gas and/or not prevent fire in all instances. Another approach is to employ a disconnector, typically a fuse, in the SPD design to disconnect the SPD from the power system. In particular, fuses are typically employed in series with MOVs, preferably with one fuse being in series with each MOV.

Under fault conditions, SPDs are faced with high (on the order of 1000 A and higher), medium (on the order of 10-1000 A) and low (on the order of 10 A or less) fault currents which typically last a number of milliseconds. In the ideal situation, an SPD disconnector design will provide adequate protection (i.e., will open the circuit) during all levels of fault current (high, medium and low) and against problematic surge currents (i.e., higher than can be adequately handled by the MOV according to its surge rating) while at the same time being able to withstand (i.e., not open) for certain surge current levels (i.e., those that than can be adequately handled by the MOV). The problem with prior art designs that use fuses to protect against MOV failure is that fuses, while effective in certain particular ranges, are not reliable over the full range of fault currents that may occur. For example, it is known to employ a fuse trace copper conductor on a printed circuit board in series with a single MOV. If fuse traces would be designed to handle relatively high surge and fault currents it they would not be suitable for disconnecting a failing MOV under relatively lower fault current conditions.

Another problem encountered by prior art SPD designs is due to the fact that it is possible, particularly under TOV conditions, to generate excessive heat in an MOV without causing a series over-current fuse to open. This excessive heat could cause damage to other components that could lead to a chain reaction of failures. Therefore, some form of thermal protection, such as a thermal fuse spring, is desirable to prevent these types of failures.

In addition, upon a failure of an MOV or its associated series fuse due to an overload condition, the MOV or fuse may disintegrate, causing electrically conductive debris to be dispersed in the vicinity of the MOV or fuse. Thus, the main technical problem in SPD disconnector design is how to control arcing between metal parts inside the SPD because the arcing in combination with the debris may cause short-circuits in any electronic circuitry in the vicinity of the MOV or fuse, including other SPD circuits. This is known as quenching the arc. Currently, arc quenching is accomplished by encapsulating the SPD in an epoxy. Epoxy, however, is very hard and therefore creates hazardous conditions under very high fault currents. Specifically, under very high fault currents, the epoxy may explode catapulting many small bullet like projectile in the general vicinity of the SPD.

One particular SPD design employing a combination of thermal disconnection and fault current protection is described in U.S. Pat. No. 6,636,409, the disclosure of which is incorporated herein by reference. FIG. 1A is a cross-sectional view of the SPD design described in U.S. Pat. No. 6,636,409. As seen in FIG. 1A, SPD 70 includes an exemplary printed circuit board (PCB) 72 and the combination of an MOV 74, a thermal fuse spring (TFS) 76 and a fuse trace with solder hole (FTWSH) 78. As is well known, the MOV 74 includes leads 80 and 82, which are inserted in respective through holes 84 and 86 of the PCB 72. The FTWSH 78 includes PCB copper traces 88 and 90 and through hole 92. The through hole 92 is positioned between the MOV lead 80 and the TFS finger 104. During wave-soldering of the PCB 72, the through holes 84, 86 and 92 are filled with solder, such as conventional solder 94 (e.g., having a melting temperature of between about 175° C. and about 250° C.) in the through hole 84 and conventional solder 96 (e.g., having a melting temperature of between about 175° C. and about 250° C.) in the through hole 92. In this manner, the MOV leads 80 and 82 are electrically connected to PCB traces, such as copper traces 90 and 98 on opposite sides of the through hole 84. Also, the solder 96 fills the through hole 92. The solder 96 is advantageously employed to shorten the disconnection time of the FTWSH 78 under overcurrent conditions by first melting and, then, hastening the disconnection (e.g., by burning) of one or both of the FTWSH PCB copper traces 88 and 90.

Before the wave-soldering process, the TFS 76 is placed on the PCB 72 during a surface mounting (re-flow) process. Preferably, a fusible alloy, such as a suitable low temperature solder, shown at 100 and 102, is employed at the fingers 104 and 106 of the TFS 76, in order to hold the TFS 76 in a stretched position. In this manner, a series electrical connection is established from PCB copper trace 108, to solder 102, to the finger 106 of the TFS 76 and through such TFS to the finger 104, to the solder 100, to the copper trace 88, to the through hole 92, to the copper trace 90, to the through hole 84, to the MOV lead 80 and, thus, to the MOV 74.

During normal operation of the SPD 70, the leakage current through the TFS 76, FTWSH 78 and MOV 74 is in the order of several μA and there is no significant temperature increase of the MOV 74, FTWSH 78 and TFS 76. However, during abnormal conditions, the temperature of the MOV 74 rises. The heat, shown at 110, is transferred through the MOV leg 80 and the copper traces 90 and 88 and through hole 92 of the FTWSH 78 to the low temperature solder 100, which is beneath the finger 104 of the TFS 76. Once the temperature of the TFS finger 104 reaches a certain temperature, e.g., about 95° C., the solder 100 sufficiently softens or melts, and the 112 of the TFS 76, which finger is biased toward the opposing finger 114, moves as shown at 115, thereby opening the circuit and disconnecting the MOV 74.

FIG. 1B is an isometric view of SPD 70′ similar to SPD 70 shown in FIG. 1A except that two parallel sets of FTWSHs and MOVs are employed with each TFS. In particular, as shown in FIG. 1B, SPD 70′ includes PCB 72′ and the combination of eight MOVs 74A-74H, the TFS unit 76, and eight FTWSH, such as shown by the FTWSH 78A and 78B for the respective MOVs 74A and 74B. The MOV 74A includes the leads 80A and 82A, and the MOV 74B includes two leads (only lead 80B is shown). The FTWSH 78A includes PCB copper traces 88A and 90A and through hole 92A, and the FTWSH 78B includes PCB copper traces 88B and 90B and through hole 92B. The through holes 92A and 92B are positioned proximate the respective MOV leads 80A and 80B. The TFS finger 104 is electrically connected to both of the traces 88A and 88B. In this manner, the TFS unit 76 includes 4 TFS members, each of which is electrically connected to two separate series combinations of a FTWSH and an MOV, with both of those FTWSH-MOV series combinations being electrically connected in parallel.

FIGS. 1C and 1D are isometric views of another particular TFS design and another particular SPD design employing that TFS design, respectively, that are described in U.S. Pat. No. 6,636,409. FIGS. 1C and 1D show respective un-stretched and stretched thermal fuse springs (TFSs) 166 and 168, which provide protection of MOVs, such as 170, 172, 174, 176, on both sides of the TFS 168 of FIG. 1D. The TFS 168 includes a middle base portion 178, which has a suitable connection, such as a central opening 180 for a conductive fastener or terminal (not shown), for electrical connection to a phase terminal P. The TFS 168 also includes a plurality of first fingers 182 and a plurality of second fingers 184. The first fingers 182 are electrically interconnected with corresponding fuse traces 186, 188 and surge protection circuits, such as the MOVs 174, 176, respectively, which are electrically connected to a common ground G. The second fingers 184 are electrically interconnected with corresponding fuse traces 190, 192 and surge protection circuits, such as the MOVs 170, 172, respectively, which are electrically connected to a common neutral N. The exemplary double-sided TFS 168 is, thus, suitable for plural phase-to-ground (P-G) and plural phase-to-neutral (P-N) connections and, hence, provides a practical and cost effective assembly.

In this example, the first finger 182, the fuse trace 186, and the MOV 174 are electrically interconnected in series between the exemplary phase terminal P and the exemplary ground terminal G. Similarly, the second finger 184, the fuse trace 190, and the MOV 170 are electrically interconnected in series between the exemplary phase terminal P and the exemplary neutral terminal N. The three terminals P, N, G are also electrically connected to a suitable power source and to a load.

While effective, the SPD designs described in U.S. Pat. No. 6,636,409 are faced with many of the problems of prior art SPD designs described herein. For example, the designs, while effective for certain low and high fault current ranges, is generally not effective for medium fault currents. Thus, the designs may not be reliable over the full range of fault currents that may occur. In addition, the designs may not effectively provide arc quenching in the case of an MOV failure.

Thus, there is room for improvement in the field of SPDs, and in particular in SPD disconnector designs that address each of the problems described above.

### SUMMARY OF THE INVENTION

According a first aspect of the present invention, a surge protection device is provided for protecting a load that is connected to at least one voltage source from a power grid. The device includes an overcurrent fuse electrically connected to the at least one voltage source, a thermal fuse spring electrically connected to the overcurrent fuse, a fuse trace electrically connected to the thermal fuse spring, and a transient suppressing element, such as an MOV or SAD, electrically connected to the fuse trace. In addition, the overcurrent fuse, the thermal fuse spring, and the transient suppressing element are electrically connected in series between the at least one voltage source and a neutral or ground connection. This configuration provides protection over the full range of fault currents because the overcurrent fuse, the thermal fuse spring, and the fuse trace have overlapping ranges and one or more of them will open in response to low, medium and high fault currents. In the preferred embodiment, the overcurrent fuse is encapsulated in a non-organic material such as silicone. As shown in FIG. 2, the device may include a plurality of thermal fuse springs electrically connected to the overcurrent fuse a plurality of parallel fuse trace combinations and a plurality of transient suppressing elements.

Another aspect of the invention relates to a surge protection device including a substrate, at least one fuse element provided on the substrate, and a molded polymeric (e.g., plastic) enclosure provided on the substrate over the at least one fuse element, wherein the at least one fuse element is received in an interior of the enclosure. The device further includes an overcurrent fuse electrically connected to the at least one fuse element, wherein the overcurrent fuse is received and held within the interior of the enclosure. In one embodiment, the interior includes at least one outer chamber and an inner chamber, wherein the at least one fuse element is received within the at least one outer chamber and wherein the overcurrent fuse is received and held within the inner chamber. Preferably, the overcurrent fuse is encapsulated in a non-organic material such as silicone. In addition, the at least one fuse element may comprise a thermal fuse spring or a plurality of thermal fuse springs. The enclosure may include a support shelf for supporting a current transformer.

A further aspect of the invention relates to a surge protection device that includes a substrate having a slot provided therein, a transient suppressing element, such as an MOV or SAD, provided on the substrate, and a thermal fuse spring provided on the substrate. The thermal fuse spring has a finger having a first end and a second end that is biased toward the first end. The first end of the finger is attached to the substrate, such as through a base forming part of the thermal fuse spring, on a first side of the slot and the second end of the finger is attached to the substrate on a second side of the slot opposite the first side. The second end, when attached to the substrate, is electrically connected to the transient suppressing element. The second end of the finger is preferably attached to the substrate and electrically connected to the first end of the fuse trace by a solder material, wherein when the solder material is caused to melt, the second end of the finger moves toward the first end of the finger over the slot. The slot serves to reduce the likelihood that an arc is generated as the second end of the finger moves toward the first end of the finger, thereby opening the fuse. A fuse trace may be provided on the substrate between the second end of the finger and the transient suppressing element. In one embodiment, the device includes a plurality of transient suppressing elements and a plurality of thermal fuse springs provided on the substrate

According to yet a further aspect of the invention, a surge protection device is provided that includes a substrate, a transient suppressing element provided on the substrate, a first trace provided on the substrate wherein the first end thereof is electrically connected to the transient suppressing element, such as an MOV or an SAD, and a second trace provided on the substrate. In addition, a wire jumper is attached to and extends above the substrate. The first end of the wire jumper is electrically connected to the second end of the first trace and the second end of the wire jumper is electrically connected to the first end of the second trace. The wire jumper increases the length of the fuse link that is provided in limited space on the surface of the substrate. Preferably, the wire jumper is encased in a non-organic material such as silicone. Also, a portion of a first surface of the substrate that includes the first and second traces and the first and second ends of the wire jumper is preferably covered by a layer of non-organic material such as silicone. Similarly, a second surface of the substrate opposite the first surface is also covered by a layer of the non-organic material. The wire jumper and the first and second traces may be made of the same metallic material, or, alternatively, may be made of different metallic materials such that the melting I²t of the wire jumper and the first and second traces are substantially equal. In one embodiment, the second end of the second trace is electrically connected to a finger of a thermal fuse spring provided on the substrate. In another embodiment, a barrier made of dielectric material, such as a polycarbonate material, is provided on the substrate beneath the wire jumper.

A still further aspect of the invention relates to a surge protection device that includes a substrate, a transient suppressing element, such as an MOV or an SAD, provided on the substrate, and a fuse link provided on the substrate. The fuse link includes a first trace provided on a first surface of the substrate, wherein the first end of the first trace is electrically connected to the transient suppressing element, a second trace provided on a second surface of the substrate opposite the first surface, wherein the first end of the second trace is electrically connected to the second end of the first trace, and a third trace provided on the first surface of the substrate, wherein the first end of the third trace is electrically connected to the second end of the second trace. In one embodiment, the longitudinal axis of each of the first, second and third traces are substantially parallel to one another. In an alternative embodiment, the longitudinal axis of the first trace and the longitudinal axis of the second trace are disposed at a first angle with respect to one another and the longitudinal axis of the second trace and the longitudinal axis of the third trace are disposed at a second angle with respect to one another. In one particular embodiment, the first angle and the second angle are substantially equal to 90 degrees. Preferably, a portion of the first surface of the substrate that includes the first and third traces and a portion of the second surface of the substrate that includes the second trace are each covered by a layer of non-organic material such as silicone. The second end of the third trace may also be electrically connected to a finger of a thermal fuse spring provided on the substrate.

In still a further aspect of the invention, a surge protection device is provided that includes a substrate, a transient suppressing element, such as an MOV or an SAD, provided on the substrate, a main fuse element provided on the substrate, and a bypass link provided in parallel with the main fuse element that has a fuse link therein that is larger than the main fuse element. The main fuse element and the bypass link are electrically connected to the transient suppressing element. The main fuse element may be, for example, a fuse trace or a thermal fuse spring. The bypass link may also include a second transient suppressing element or a capacitor connected in series with the fuse link.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1A is a cross-sectional view of a prior art SPD design;

FIG. 1B is an isometric view of a prior art SPD design similar to the design of FIG. 1;

FIG. 1C is an isometric view of a prior art TFS design;

FIG. 1D is an isometric view of another prior art SPD design that employs the TFS design of FIG. 1C;

FIG. 2 is a block diagram of an SPDD design according to an aspect of the present invention;

FIGS. 3A, 3B and 3C are top plan, cross sectional and isometric views of a fuse holder according to a further aspect of the present invention;

FIG. 3D is an isometric view of an overcurrent fuse and a pair of terminals forming a part of the fuse holder shown in FIGS. 3A-3C;

FIG. 4 is a top plan view of a printed circuit board including an SPDD having a number of the fuse holders of FIGS. 3A-3C provided thereon;

FIG. 5A is a side view, in partial cross-section, of an SPDD according to a further aspect of the present invention;

FIGS. 5B and 5C are isometric views of a portion of the SPDD shown in FIG. 5A;

FIG. 6A is a side view, in partial cross-section, and FIG. 6B is an isometric view of a portion of an SPDD according to yet a further aspect of the present invention;

FIG. 7A is a side view, in partial cross-section, and FIG. 7B is an isometric view of a portion of an alternate embodiment of an SPDD according to yet a further aspect of the present invention;

FIGS. 8A, 8B and 8C are schematic diagrams of various different embodiments of a fuse link according to still yet a further aspect of the present invention; and

FIGS. 9A-9F are schematic diagrams of a number of different configurations for controlling/mitigating the voltage on a fuse when it operates according to yet a further aspect of the present invention.

### DESCRIPTION OF THE PREFERRED EMBODIMENTS

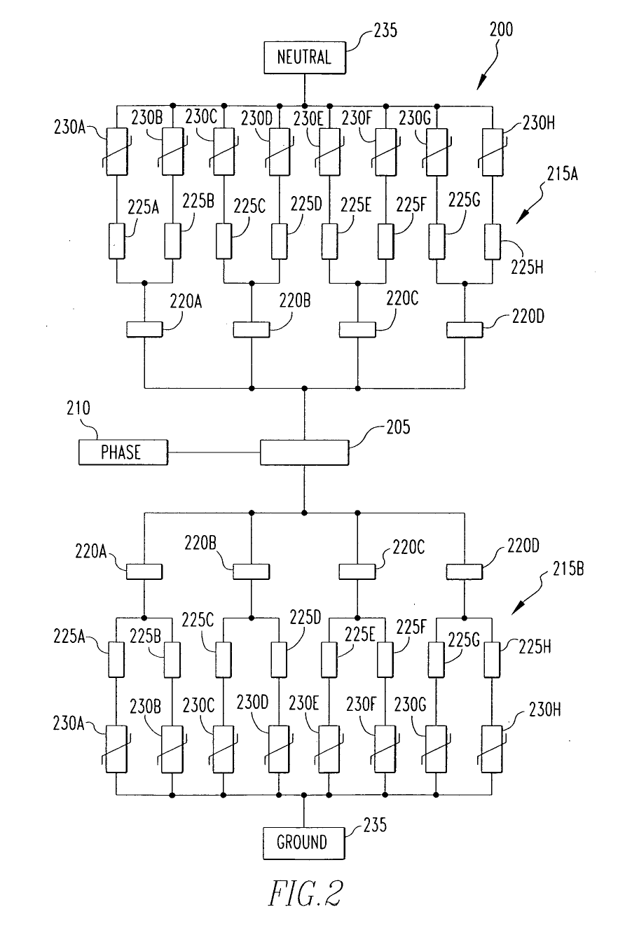

FIG. 2 is a schematic diagram of a surge protection device disconnector (SPDD) 200 according to an aspect of the present invention. SPDD 200 includes an overcurrent fuse 205 that is electrically connected to a phase conductor 210 of the electrical distribution system.

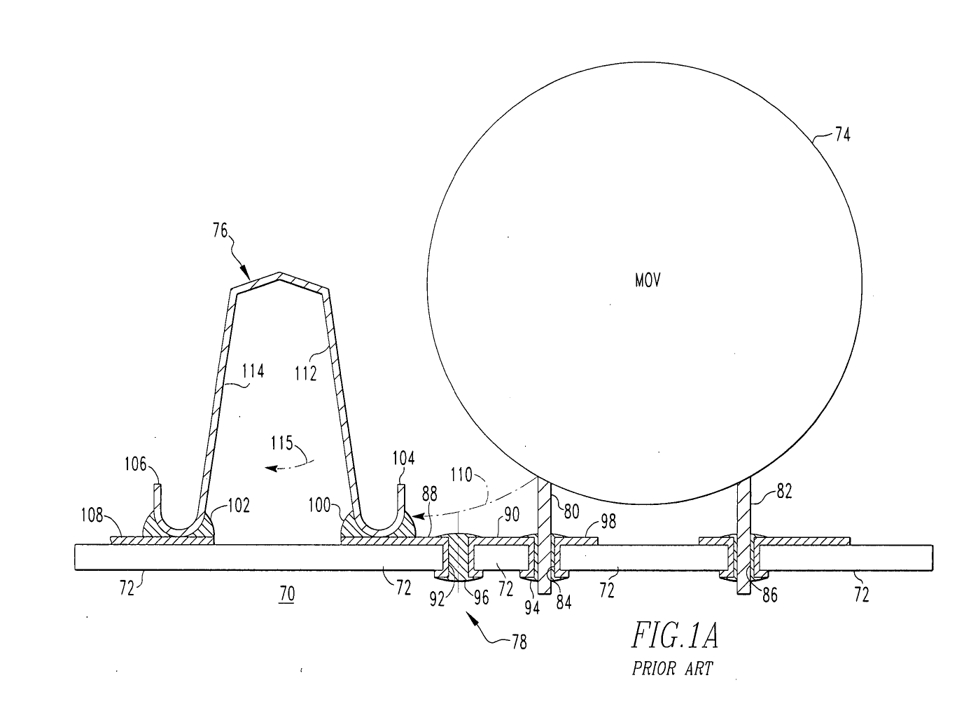

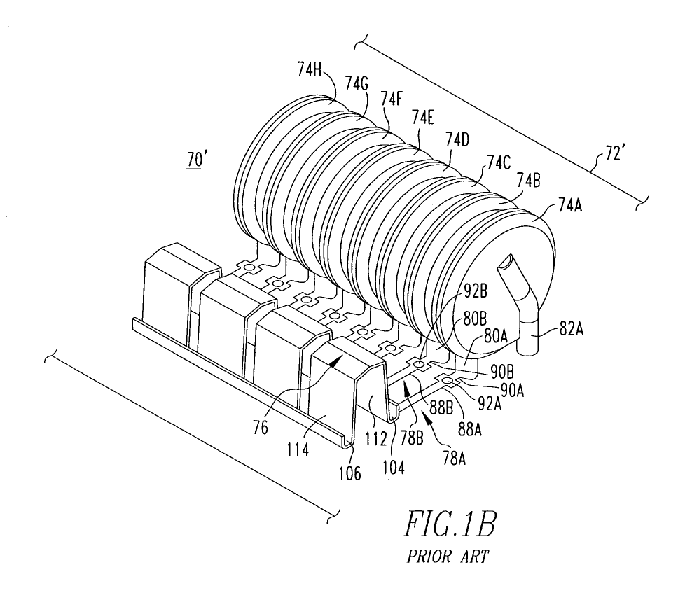

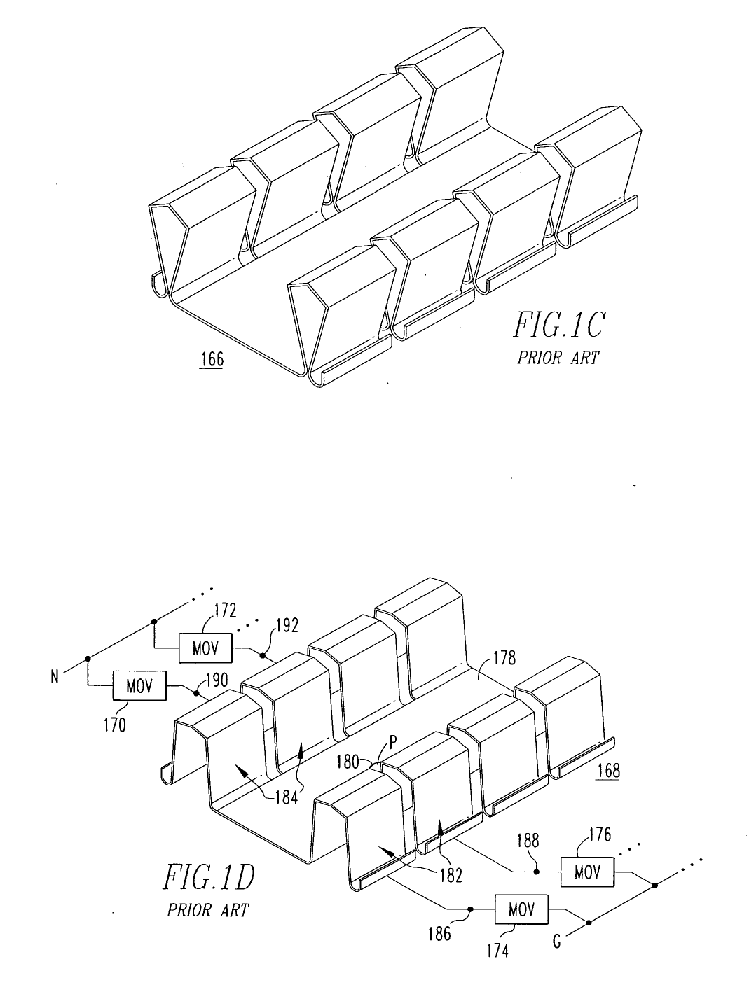

The SPDD 200 includes a first branch 215A and a second branch 215B which are identical to one another. Preferably, the first and second branches 215A and 215B are each similar in structure to the SPD′ 70 shown in FIG. 1B and described above or the SPD shown in FIG. 1D. For clarity, only the first branch 215A will be described, but it will be understood that the second branch 215B includes identical components. The first branch 215A includes thermal fuse springs (TFS) 220A, 220B, 220C and 220D in the form shown in either FIG. 1A or FIGS. 1C and 1D which are each electrically connected to the overcurrent fuse 205 as seen in FIG. 2. The thermal fuse springs (TFS) 220A, 220B, 220C and 220D are preferably part of a TFS unit such as the TFS unit 76 shown in FIG. 1B or the TFS units 166, 168 shown in FIGS. 1C and 1D. Each TFS 220A-220D will open due to heat that is generated in the MOVs 230A-230H (described below) of the first branch 215A and will effectively function in the low and medium fault current range, meaning that it will open in the presence of such fault currents. The first branch 215A also includes fuse traces 225A-225H each in the form of fuse trace with solder hole (FTWSH) 78 shown in FIG. 1A and described above. As seen in FIG. 2, each TFS 220-220D is connected to a respective pair of the fuse traces 225A-225H in the manner shown in FIGS. 1A and 1B or FIG. 1D. Each of the fuse traces 225A-225H will effectively function in the medium fault current range, meaning that it will open in the presence of such fault currents, but will not open in the presence of certain low range fault currents. Finally, the first branch 215A includes MOVs 230A-230H, each connected to a respective one of the fuse traces 225A-225H in the manner shown in FIGS. 1A and 1B or FIG. 1D. Furthermore, one of the leads of each MOV 230A-230H is connected to a neutral or ground conductor 235 of the electrical distribution system. As will be appreciated, other transient suppressing elements, such as SADs, may be substituted for the MOVs 230A-230H. Thus, as will be appreciated, according to an aspect of the present invention, the SPDD 200 shown in FIG. 2 will provide protection over the entire range of fault currents, i.e., it will provide protection against high, medium and low fault currents. The operating ranges of each of the three types of fuses (overcurrent, TFS and fuse trace) will vary with system voltage and time (phase angle) of the fault. Also, the ranges of the three types of fuses are preferably overlapping, meaning that under certain conditions, two or even three of the fuse types might respond (open) at the same time to a particular fault condition. In particular, the operating range of the overcurrent fuse preferably overlaps the operating range of the fuse terraces, and the operating range of the fuse traces preferably overlaps the operating range of the TFSs. For example, one TFS finger and one fuse trace might open (disconnect) the circuitry at fault conditions of 100 A fault current and a duration of 5 s.

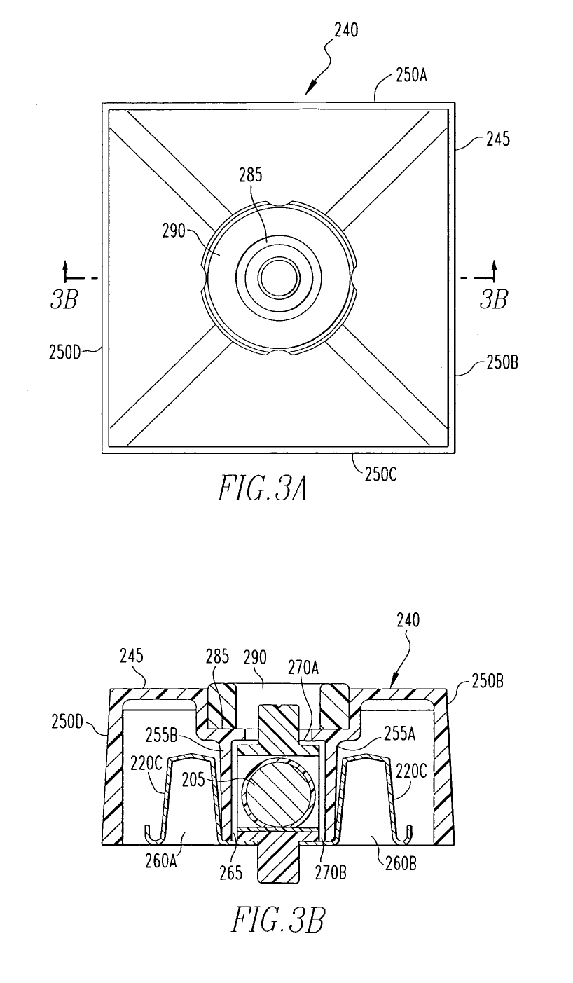

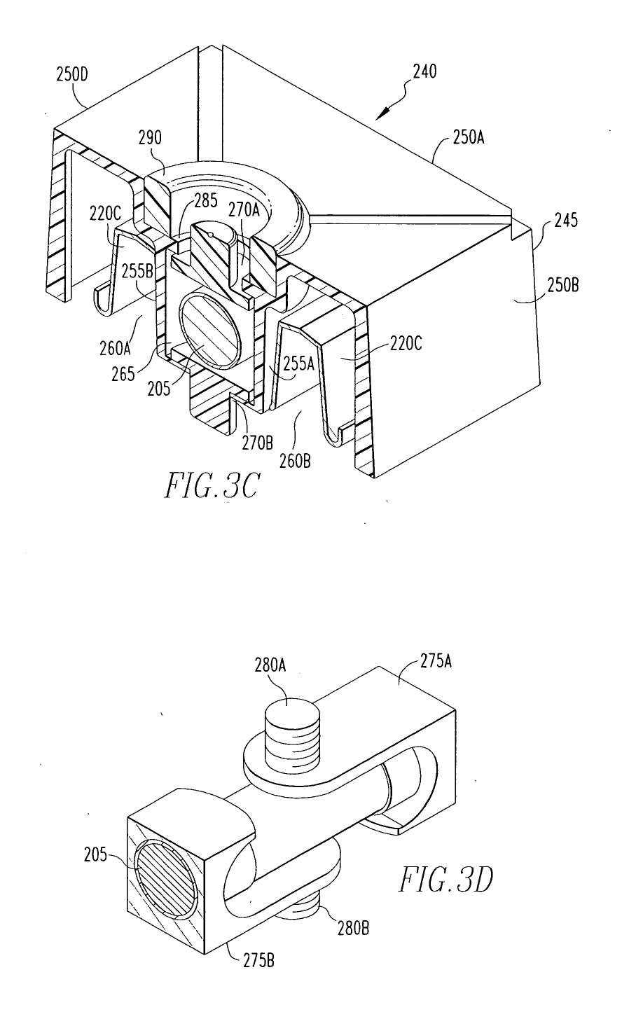

FIGS. 3A, 3B, 3C and 3D show a number of different views of a fuse holder 240 according to a further aspect of the present invention. As described in greater detail below, the fuse holder 240 is designed to prevent various types of arcing associated with an SPDD design such as SPDD 200. The fuse holder 240 includes a molded enclosure 245 preferably having a square cross-section. The molded enclosure 245 is made of a polymeric material such as polycarbonate or another plastic material. The enclosure 245 includes external walls 250A, 250B, 250C and 250D and internal walls 255A and 255B. The external walls 250B and 250D and the internal walls 255A and 255B together form outer chambers 260A and 260B therebetween. In addition, the internal walls 255A and 255B define a generally rectangular inner chamber 265 including top and bottom apertures 270A and 270B. The fuse holder 240 also includes first and second terminals 275A and 275B (FIG. 3D) for holding and making electrical connections to the overcurrent fuse 205. The first and second terminals 275A and 275B each include a threaded terminal connector 280A and 280B for making electrical connections thereto. As seen in FIGS. 3B and 3C, the first and second terminals 275A and 275B having the overcurrent fuse 205 held therein are adapted to be received and held within the inner chamber 265. In this configuration, the threaded terminal connector 280A extends through the aperture 270A and the threaded terminal connector 280B extends through the aperture 270B. As also seen in FIGS. 3B and 3C, the fuse holder 240 is adapted to be placed over the TFSs 220A-220D in the first and second branches 215A and 215B of the SPDD 200 shown in FIG. 2, in which case the TFSs 220A-220D are received within the outer chambers 260A and 260B. Similarly, the fuse holder 240 may be placed over the TFS units 166, 168 shown in FIGS. 1C and 1D. Finally, the enclosure 245 includes a shelf 285 for holding an annular current transformer 290 which measures the current flowing through the overcurrent fuse 205.

It has been found during testing that the surface of the overcurrent fuse 205, if exposed to air, burns due to heat generated inside the overcurrent fuse 205 Thus, in the preferred embodiment of the fuse holder 240, the overcurrent fuse 205 is embedded in a non-organic material such as, without limitation, silicone. The non-organic material (e.g., silicone) provides a cooling effect for the body of the overcurrent fuse 205 during medium fault current conditions. By increasing thermal mass of the SPDD 200, the non-organic material does not change the response time of the overcurrent fuse 205 under high fault current conditions, but does keep the temperature of the surface of the overcurrent fuse 205 down during medium fault current conditions. In addition, typical, off the shelf fuses that may be used for overcurrent fuse 205 are not designed to operate for fault currents below a certain level, and may explode or burn in that region. With the benefit of the cooling effect of the non-organic material as described above, the minimum fault current at which the overcurrent fuse 205 will operate can be reduced, thus allowing the overcurrent fuse 205 to be effective over a greater range.

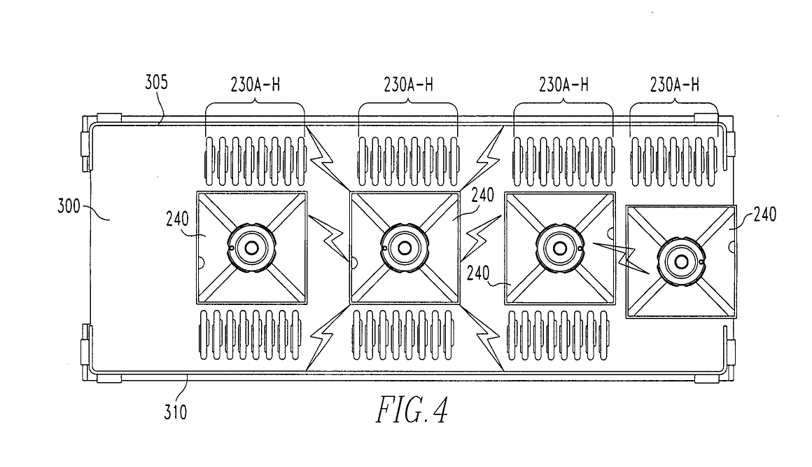

FIG. 4 is a schematic diagram showing four fuse holders 240 mounted on a PCB 300 having a ground bus bar 305 and a neutral bus bar 310. The fuse holders 240 prevent arcing between the different metal parts, namely the TFSs 220A-220D and the ground and neutral bus bars. As will be appreciated, these metal parts are connected to different voltage potentials isolated by air. The air provides sufficient dielectric strength under normal conditions, but when contaminated by metal-oxide dust, ionized gas and/or plasma, such as in the case of an explosive failure of an MOV, the spacing between the parts might not be large enough to prevent severe arcing, which tends to occur in the areas shown by the arrows in FIG. 4. Placing barriers between these parts, in the form of the fuse holders 240, prevents the arcing.

Thus, the fuse holder 240 performs at least the following functions: (i) holding the overcurrent fuse 205, (ii) holding the current transformer 290 (FIG. 3A), (iii) preventing arcing from one TFS to another, and (iv) preventing arcing from a TFS to a ground and/or neutral bus bar (FIG. 4).

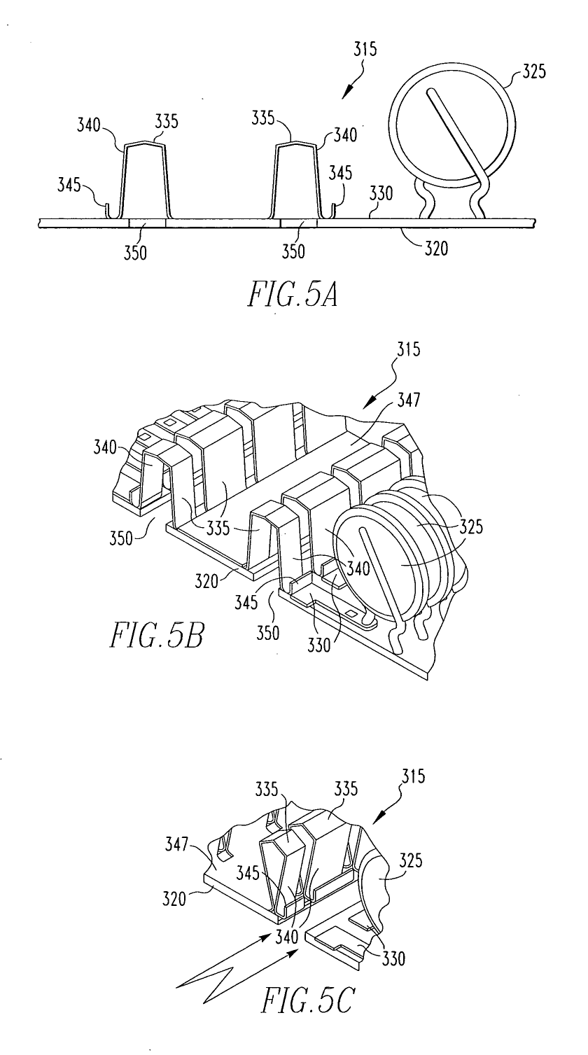

FIGS. 5A, 5B and 5C show portions of an SPDD 315 according to a further aspect of the present invention. The SPDD 315 is similar to the SPDs 70 and 70′ shown in FIGS. 1A and 1B and the SPD shown in FIG. 1D in that it includes a PCB 320 having a number of MOVs 325, a number of fuse traces (with solder holes) 330, and thermal fuse springs (TFSs) 335 having fingers 340 having ends 345 provided/mounted thereon. As described in connection with FIGS. 1A and 1B, each of the ends 345 of the finger 340 is connected to a respective fuse trace 330 by a fusible alloy, such as a suitable low temperature solder, in order to hold each TFS 335 in a stretched position. In this manner, a series electrical connection is established from each MOV 325 to a respective fuse trace 330 to a respective TFS 335. In the preferred embodiment (shown in FIG. 5A-C), the TFSs 335 are part of a TFS unit in the form shown in FIGS. 1C and 1D. In that type of configuration, the TFS unit includes a base 347 that is attached to the PCB 320 by mechanical means, wherein an inner end of each of the fingers 340 (the end opposite the end 345) is attached to the base 347.

As described above, under certain conditions, a TFS 335 will trip. Specifically, under certain conditions the solder at the end 345 of the finger 340 of a TFS 335 will melt and release the finger 340 from its stretched position back to a tripped position (where the end 345 of the finger 340 is closer to the base 347 as seen in FIG. 5C). Normally, during such tripping an arc would be formed between the finger 340 and the PCB 320 (this is the case with the SPDs 70 and 70′ shown in FIGS. 1A and 1b and the SPD shown in FIG. 1D). While the end of the finger 340 moves toward the base 347, the arc is dragged along the PCB 320. Such an arc may cause other, bigger arcs between other metal parts. The arcing is exacerbated due to the fact that carbon traces (or traces from other contaminants) are typically left on the PCB when a fuse opens. However, according to an aspect of the present invention, such arcing is prevented by providing a slot 350 in the PCB 320 beneath each TFS 335 in between the end of the finger 340 and the base 347. This is the case because the slot 350 increases the dialectic strength (by a factor of approximately 2) of the space between the base 347 and the portion of the PCB 320 to which the end 345 of the finger 340 was soldered, thereby significantly reducing arcing conditions. In the preferred embodiment, the slot is about 0.2 inches wide.

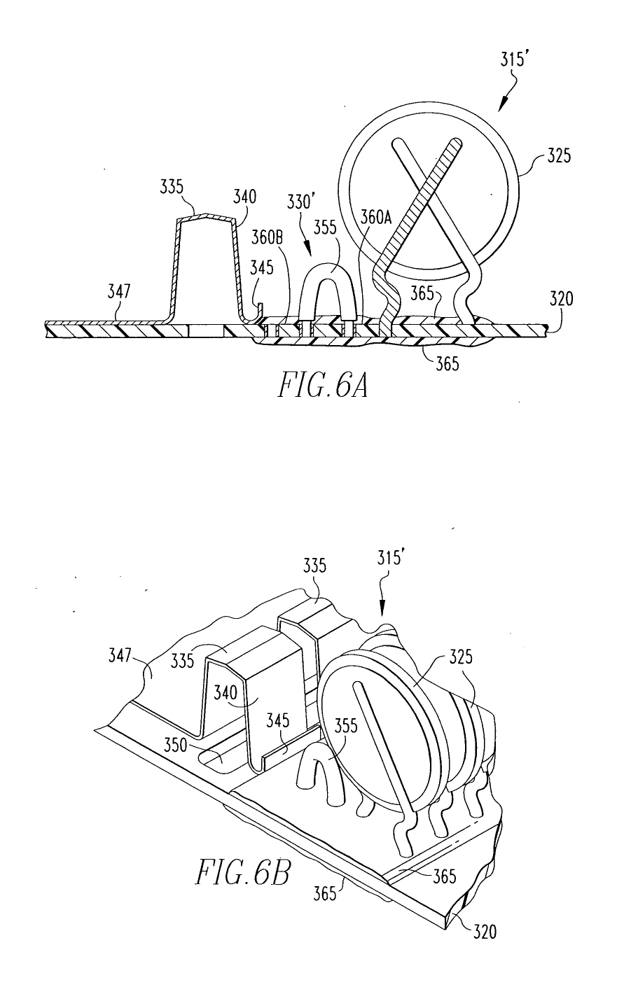

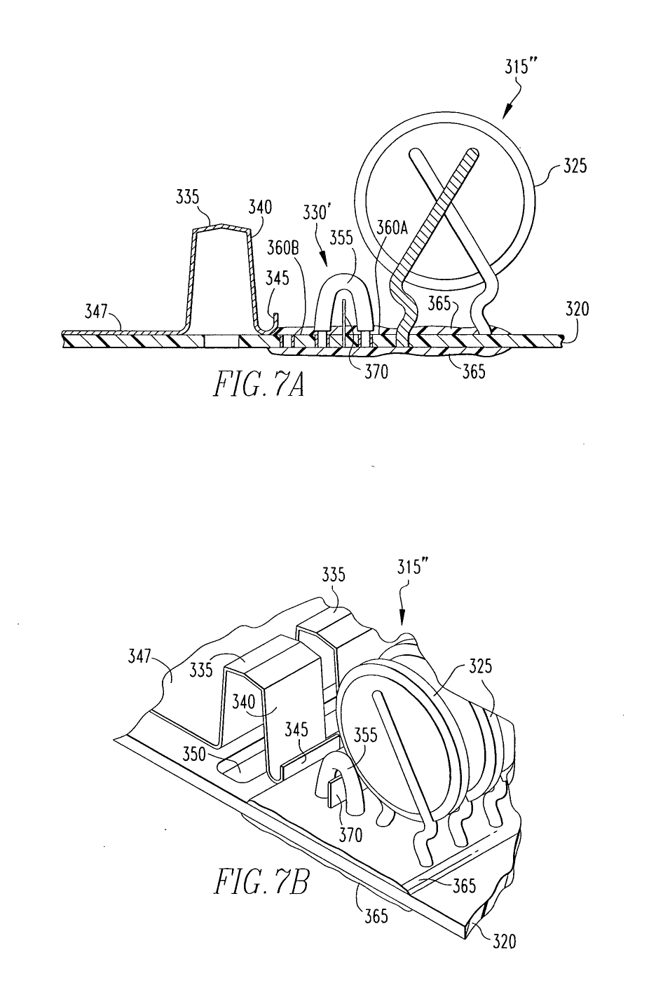

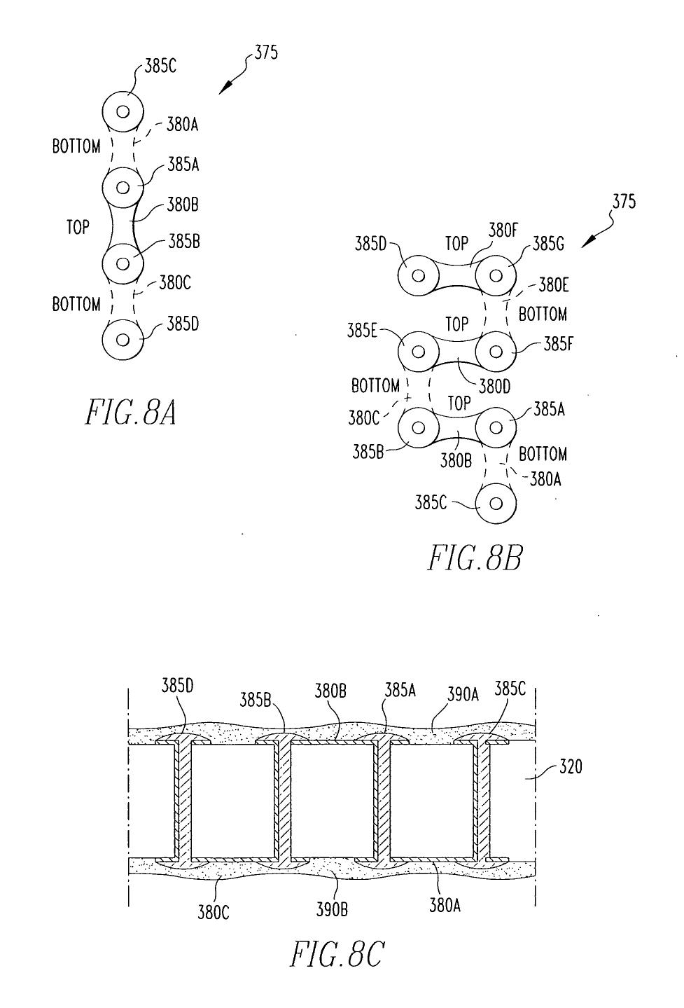

FIGS. 6A and 6B show portions of an alternative embodiment of the SPDD 315 shown in FIGS. 5A, 5B and 5C, designated as SPDD 315′, that includes a modified fuse trace 330′. As stated elsewhere herein, the fuse traces have to open at fault currents in the medium range (e.g., 10 A-1000 A). For such a fault range, usually only one MOV 325 is failing at a time, which means only one fuse trace at a time has to operate. In order to clear the fault current properly at a high voltage (e.g., on the order of 600 Vac), the fuse trace has to have a certain length, and optimally should be as long as possible. Thus, according to an aspect of the present invention, fuse trace 330′ includes a mechanism for increasing the length thereof (as compared to fuse trace 330). In particular, a wire jumper 355 preferably encased in a silicone tube (or a tube made of another non-organic material) is provided between and electrically connected to a first trace 360A provided on the PCB 320 at one end thereof and a second trace 360B provided on the PCB 320 at the opposite end thereof. The first trace 360A is also electrically connected to the MOV 325 in a manner described elsewhere herein, and the second trace 360B is electrically connected to the end 345 of the finger 340 of the TFS 335 by the low temperature solder. Preferably, the wire jumper 355 is electrically connected to the first and second traces 360A and 360B my means of solder holes provided in the PCB 320. In addition, as seen in FIGS. 6A and 6B, the first and second traces 360A and 360B, the ends of the wire jumper, the leads of the MOV 325, and the top and bottom of the adjacent portions of the PCB 320 are covered by a silicone layer 365 (or a layer of another suitable non-organic material). The silicone tube surrounding the wire jumper 355 helps to quench arcing during the fuse opening period and the silicone layer 365 helps to quench arcing over the surfaces of the PCB 320 from one via through-hole to another via through-hole by preventing contaminants form being released into the air. The total cross-section of the first and second traces 360A and 360B and the wire jumper 355 may be made of the same metal. Alternatively, the first and second traces 360A and 360B and the wire jumper 355 may be made of different metals by suitably selecting cross-sections that will make the melting I²t of the elements substantially the same.

FIGS. 7A and 7B show portions of an alternative embodiment of the SPDD 315′, designated as SPDD 315″. The SPDD 315″ differs from the SPDD 315′ in that it further includes a barrier 370 provided below the wire jumper 355. The barrier 370 is made of a dielectric material having a dielectric strength higher than air, such as a polycarbonate material like Lexan. The barrier 370 is preferably an elongated, rectangular shaped element inserted into a slot provided in the PCB 320. The barrier 370 provides further isolation between the ends of the wire jumper 355 and the first and second traces 360A and 360B, thereby helping to prevent arcing. In addition, although both SPDD315′ and SPDD 315″ are shown as having the slot 350, it will be appreciated that the wire jumper 355 and silicone layer 365 may be used in embodiments that do not include the slot 350.

Due to space limitations present in prior are SPDD designs (i.e., the limited space available on the PCBs), the fuse traces used therein have typically been very short. However, the shorter the fuse trace, the more likely that arcing will occur when the fuse trace opens. Thus, according to a further aspect of the present invention, a number of fuse link designs are provided which serve to increase the effective length of a fuse trace by providing traces on both sides of a PCB. FIG. 8A is a schematic diagram of a first embodiment of a fuse link 375 according to an aspect of the present invention. The fuse link 375 includes a first conductive trace (e.g., a copper trace) 380A provided on a bottom surface of a PCB (not shown), a second conductive trace (e.g., a copper trace) 380B provided on a top surface of a PCB (not shown), and a third conductive trace (e.g., a copper trace) 380C provided on the bottom surface of a PCB (not shown). The first conductive trace 380A is electrically connected the second conductive trace 380B through solder filled via 385A and the second conductive trace 380B is electrically connected the third conductive trace 380C through solder filled via 385B. In addition, solder filled via 385C is provided to enable the first conductive trace 380A to be electrically connected to the lead of an MOV (not shown), such as MOV 325 shown in FIGS. 5A-5C, 6A and 6B, and 7A and 7B, and solder filled via 385D is provided to enable the third conductive trace 380A to be electrically connected to the finger of a TFS, such as TFS 335 shown in FIGS. 5A-5C, 6A and 6B, and 7A, through, for example, an additional trace and solder. FIG. 8B is a schematic diagram of a second embodiment of the fuse link, designated at 375′, according to a further aspect of the present invention. In the embodiment shown in FIG. 8B, the fuse traces 380A-380F are alternately provided on the top and bottom sides of the PCB (not shown) in a manner such that the longitudinal axis of adjacent fuses traces 380A-380F are angled with respect to one another. In the preferred embodiment shown in FIG. 8B, the angle is about 90°, although other angles are possible. This is in contrast to the first embodiment shown in FIG. 8A in which the longitudinal axis of adjacent fuses traces 380A-380C are substantially parallel to one another. According to a further, preferred aspect of the present invention shown in FIG. 8C, the fuse link 375 (or 375′) includes a first layer of silicone 390A (or another suitable non-organic material) that covers the vias and the fuse traces on the top surface of the PCB and a second layer of silicone 390B (or another suitable non-organic material) that covers the vias and the fuse traces on the bottom surface of the PCB, which layers 390A and 390B have arc extinguishing properties. Another advantage of the fuse links 375 and 375′ is that they have multiple break points. The multiple break points (gaps) will result in a number of smaller arcs (each fuse gap will arc) as opposed to a single large arc (when only one gap is present). As will be appreciated, it is easier to extinguish multiple small arcs as opposed to a single large arc.

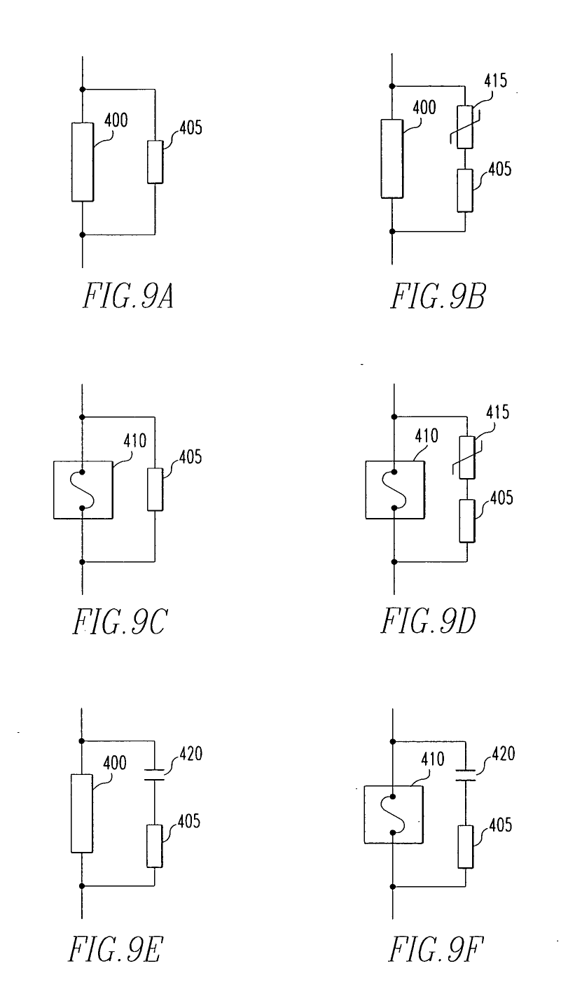

Moreover, it is known that the voltage across the terminals of a fuse rises when the fuse opens under fault conditions such as those described herein. It is therefore desirable to keep that voltage as low as possible in order to prevent arcing between the fuse terminals due to the dielectric breakdown of the air between the terminals. FIGS. 9A-9F show a number of different configurations for controlling/mitigating the voltage on a fuse when it operates (opens) according to yet a further aspect of the present invention. FIG. 9A shows a first embodiment of an arrangement for mitigating voltage that includes a main fuse link 400 and a bypass link having bypass fuse link 405 connected in parallel therewith. The main fuse link 400 may be any fuse link, such as, without limitation, the fuse traces 225A-H, the fuse traces 330 and 330′, and the fuse links 375 and 375′ described herein. The main fuse link 400 is smaller than the bypass fuse link 405, which functions to redirect the fault current once the main fuse link 400 opens. The term smaller as used herein means that the main fuse link 400 has a smaller impedance than and/or a lower rms fault current rating than the bypass fuse link 400. As a result, instead of arcing through the remains of the open (melted) main fuse link 400, the fault current will flow through the relatively larger bypass fuse link 405. Because the bypass fuse link 405 is larger, it is easier to control arcing once it opens. FIG. 9C shows an alternate arrangement employing the bypass fuse link 405 wherein the main fuse link 400 is replaced with a thermal fuse spring 410, such as TFS 335 described herein. The principles of operation remain the same. FIGS. 9B and 9D show still further alternative arrangements (using a main fuse link 400 and a thermal fuse spring, respectively) wherein a low-clamping (i.e., 10-20% of the nominal voltage) MOV 415 is provided in series with the bypass fuse link 405 in the bypass link. The low-clamping MOV 415 will clamp and conduct the re-directed fault current once the main fuse link 400 or thermal fuse spring 410 operates. The bypass fuse link 405 can have a longer length than the main fuse link 400 and will have a much smaller arc than the main fuse link arc, which means that the clearing time will be shorter. The arc for the by-pass fuse link 405 will be smaller because the by-pass fuse link 405 has a higher impedance, better heat dissipation (due to its longer length) and a smaller voltage drop. Finally, FIGS. 9E and 9F show still further alternative arrangements (using a main fuse link 400 and a thermal fuse spring, respectively) wherein a capacitor 420 is provided in series with the bypass fuse link 405 in the bypass link. In this case, the bypass fuse link 405 has a low impedance (in the milliohms range) at higher arc frequencies (in the range from 10^{th} harmonics to RF).

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A surge protection device for protecting a load connected to at least one voltage source from a power source, comprising:
an overcurrent fuse electrically connected to said at least one voltage source;
a thermal fuse spring electrically connected to said overcurrent fuse;
a fuse trace electrically connected to said thermal fuse spring; and
a transient suppressing element electrically connected to said fuse trace;
wherein said overcurrent fuse, said thermal fuse spring, said fuse trace and said transient suppressing element are electrically connected in series between said at least one voltage source and a neutral or ground connection.

2. The surge protection device according to claim 1, wherein said transient suppressing element is an MOV.

3. The surge protection device according to claim 1, wherein said transient suppressing element is an SAD.

4. The surge protection device according to claim 1, wherein an operating range said overcurrent fuse overlaps an operating range of said fuse trace and said operating range of said fuse trace overlaps an operating range of said thermal fuse spring.

5. The surge protection device according to claim 4 wherein said overcurrent fuse is encapsulated in a non-organic material.

6. The surge protection device according to claim 1, wherein said overcurrent fuse is encapsulated in a non-organic material.

7. The surge protection device according to claim 6, wherein said non-organic material is silicone.

8. A surge protection device for protecting a load connected to at least one voltage source from a power source, comprising:
an overcurrent fuse electrically connected to said at least one voltage source;
a plurality of thermal fuse springs electrically connected to said overcurrent fuse;
a plurality of fuse trace combinations, each of said fuse trace combinations including a plurality of fuse traces connected in parallel, each of said thermal fuse springs being electrically connected in series to a respective one of said fuse trace combinations; and
a plurality of transient suppressing elements, each of said fuse traces being electrically connected in series to a respective one of said transient suppressing elements, each of said transient suppressing elements being electrically connected to a neutral or ground connection.

9. The surge protection device according to claim 5, wherein each of said transient suppressing elements is an MOV.

10. The surge protection device according to claim 5, wherein each of said transient suppressing elements is an SAD.

11. The surge protection device according to claim 5, wherein an operating range said overcurrent fuse overlaps an operating range of said fuse traces and said operating range of said fuse traces overlaps an operating range of said thermal fuse springs.

12. The surge protection device according to claim 8, wherein said overcurrent fuse is encapsulated in a non-organic material.

13. The surge protection device according to claim 12, wherein said non-organic material is silicone.

14. A surge protection device, comprising:
a substrate;
at least one fuse element provided on said substrate;
a polymeric enclosure provided on said substrate over said at least one fuse element, said at least one fuse element being received in an interior of said enclosure; and
an overcurrent fuse electrically connected to said at least one fuse element, said overcurrent fuse being received and held within said interior of said enclosure.

15. The surge protection device according to claim 14, wherein said interior includes at least one outer chamber and an inner chamber, wherein said at least one fuse element is received within said at least one outer chamber and wherein said overcurrent fuse is received and held within said inner chamber.

16. The surge protection device according to claim 15, wherein said enclosure includes a plurality of external walls and a plurality of internal walls, said at least one outer chamber being defined between one or more of said external walls and one or more of said internal walls, and said inner chamber being defined by said internal walls.

17. The surge protection device according to claim 14, wherein said overcurrent fuse is encapsulated in a non-organic material.

18. The surge protection device according to claim 17, wherein said non-organic material is silicone.

19. The surge protection device according to claim 14, wherein said at least one fuse element comprises a thermal fuse spring.

20. The surge protection device according to claim 15, wherein said at least one outer chamber includes a first outer chamber and a second outer chamber, and wherein said at least one fuse element comprises one or more first thermal fuse springs received within said first outer chamber and one or more second thermal fuse springs received within said second outer chamber.

21. The surge protection device according to claim 14, wherein said enclosure is made of a plastic material.

22. The surge protection device according to claim 21, wherein said plastic material is a polycarbonate material.

23. The surge protection device according to claim 14, wherein the enclosure includes a support shelf, said support shelf supporting a current transformer.

24. The surge protection device according to claim 14, wherein said overcurrent fuse is held by and electrically connected to a first terminal and a second terminal, said overcurrent fuse being electrically connected to said at least one fuse element through said first terminal.

25. A surge protection device, comprising:
a substrate having a slot provided therein;
a transient suppressing element provided on said substrate; and
a thermal fuse spring provided on said substrate, said thermal fuse spring having a finger having a first end and a second end, said second end being biased toward said first end, said first end being attached to said substrate on a first side of said slot and said second end being attached to said substrate on a second side of said slot opposite said first side, said second end, when attached to said substrate, being electrically connected to said transient suppressing element.

26. The surge protection device according to claim 25, wherein said transient suppressing element is an MOV.

27. The surge protection device according to claim 25, wherein said transient suppressing element is an SAD.

28. The surge protection device according to claim 25, wherein a fuse trace is provided on said substrate between said second end of said finger and said transient suppressing element, a first end of said fuse trace being electrically connected to said second end of said finger when said second end is attached to said substrate and a second end of said fuse trace being electrically connected to said transient suppressing element.

29. The surge protection device according to claim 28, wherein said second end of said finger is attached to said substrate and electrically connected to said first end of said fuse trace by a solder material, wherein when said solder material is caused to melt, said second end of said finger moves toward said first end of said finger over said slot.

30. The surge protection device according to claim 25, wherein said second end of said finger is attached to said substrate and electrically connected to said transient suppressing element through a solder material, wherein when said solder material is caused to melt, said second end of said finger moves toward said first end of said finger over said slot.

31. The surge protection device according to claim 25, wherein said first end of said finger is attached to said substrate by being attached to a base that is attached to said substrate.

32. A surge protection device, comprising:
a substrate having a longitudinal slot provided therein;
a plurality of transient suppressing elements provided on said substrate; and
a plurality of thermal fuse springs provided on said substrate, each of said thermal fuse springs having a finger having a first end and a second end biased toward said first end, said first end of each finger being attached to said substrate on a first side of said slot and said second end of each finger being attached to said substrate on a second side of said slot opposite said first side, said second end of each finger, when attached to said substrate, being electrically connected to a respective one of said transient suppressing elements.

33. The surge protection device according to claim 32, wherein each of said transient suppressing elements is an MOV.

34. The surge protection device according to claim 32, wherein each of said transient suppressing elements is an SAD.

35. The surge protection device according to claim 32, wherein a plurality of fuse traces are provided on said substrate, each of said fuses traces being provided between the second end of a respective finger and a respective one of said transient suppressing elements, a first end of each of said fuse traces being electrically connected to said second end of the respective finger when said second end is attached to said substrate and a second end of each of said fuse traces being electrically connected to the respective transient suppressing element.

36. The surge protection device according to claim 35, wherein said second end of each finger is attached to said substrate and electrically connected to said first end of a respective one of said fuse traces by a solder material, wherein when said solder material is caused to melt, said second end of said respective finger moves toward said first end of said respective finger over said slot.

37. The surge protection device according to claim 32, wherein said second end of each finger is attached to said substrate and electrically connected to a respective one of said transient suppressing elements through a solder material, wherein when said solder material is caused to melt, said second end of said respective finger moves toward said first end of said respective finger over said slot.

38. The surge protection device according to claim 32, wherein said first end of each finger is attached to said substrate by being attached to a base that is attached to said substrate.

39. A surge protection device, comprising:
a substrate;
a transient suppressing element provided on said substrate;
a first trace provided on said substrate having a first end and a second end, said first end of said first trace being electrically connected to said transient suppressing element;
a second trace provided on said substrate having a first end and a second end; and
a wire jumper attached to and extending above said substrate, said wire jumper having a first end and a second end, said first end of said wire jumper being electrically connected to said second end of said first trace and said second end of said wire jumper being electrically connected to said first end of said second trace.

40. The surge protection device according to claim 39, wherein said transient suppressing element is an MOV.

41. The surge protection device according to claim 39, wherein said transient suppressing element is an SAD.

42. The surge protection device according to claim 39, wherein said wire jumper is encased in a non-organic material.

43. The surge protection device according to claim 42, wherein said non-organic material is silicone.

44. The surge protection device according to claim 39, wherein said wire jumper and said first and second traces are made of the same metallic material.

45. The surge protection device according to claim 39, wherein said wire jumper and said first and second traces are made of different metallic materials and wherein the melting I²t of said wire jumper and said first and second traces are substantially equal.

46. The surge protection device according to claim 39, wherein a portion of a first surface of said substrate that includes said first and second traces and said first and second ends of said wire jumper is covered by a layer of non-organic material.

47. The surge protection device according to claim 46, wherein said non-organic material is silicone.

48. The surge protection device according to claim 46, wherein a portion of a second surface of said substrate opposite said first surface is covered by a second layer of said non-organic material.

49. The surge protection device according to claim 48, wherein said non-organic material is silicone.

50. The surge protection device according to claim 39, wherein said second end of said second trace is electrically connected to a finger of a thermal fuse spring provided on said substrate.

51. The surge protection device according to claim 39, wherein a barrier made of dielectric material is provided on said substrate beneath said wire jumper.

52. The surge protection device according to claim 51, wherein said barrier is made of a polycarbonate material.

53. The surge protection device according to claim 51, wherein said barrier is substantially flat and extends upwardly form said substrate.

54. A surge protection device, comprising:
a substrate;
a transient suppressing element provided on said substrate; and
a fuse link provided on said substrate, said fuse link including:
a first trace provided on a first surface of said substrate, said first trace having a first end and a second end, said first end of said first trace being electrically connected to said transient suppressing element;
a second trace provided on a second surface of said substrate opposite said first surface, said second trace having a first end and a second end, said first end of said second trace being electrically connected to said second end of said first trace; and
a third trace provided on said first surface of said substrate, said third trace having a first end and a second end, said first end of said third trace being electrically connected to said second end of said second trace.

55. The surge protection device according to claim 54, wherein said first, second and third traces each have a longitudinal axis extending along the length thereof, the longitudinal axis of each of said first, second and third traces being substantially parallel to one another.

56. The surge protection device according to claim 54, wherein said first, second and third traces each have a longitudinal axis extending along the length thereof, the longitudinal axis of said first trace and the longitudinal axis of said second trace being disposed at a first angle with respect to one another and the longitudinal axis of said second trace and the longitudinal axis of said third trace being disposed at a second angle with respect to one another.

57. The surge protection device according to claim 56, wherein said first angle and said second angle are substantially equal to 90 degrees.

58. The surge protection device according to claim 54, wherein a portion of said first surface of said substrate that includes said first and third traces and a portion of said second surface of said substrate that includes said second trace are each covered by a layer of non-organic material.

59. The surge protection device according to claim 58, wherein said non-organic material is silicone.

60. The surge protection device according to claim 54, wherein said second end of said third trace is electrically connected to a finger of a thermal fuse spring provided on said substrate.

61. The surge protection device according to claim 54, wherein said transient suppressing element is provided on said first surface of said substrate.

62. The surge protection device according to claim 54, wherein said transient suppressing element is provided on said second surface of said substrate.

63. The surge protection device according to claim 54, wherein said transient suppressing element is an MOV.

64. The surge protection device according to claim 54, wherein said transient suppressing element is an SAD.

65. A surge protection device, comprising:
a substrate;
a transient suppressing element provided on said substrate;
a main fuse element provided on said substrate; and
a bypass link provided in parallel with said main fuse element, said bypass link having a fuse link;
wherein said main fuse element and said bypass link are electrically connected to said transient suppressing element and wherein said main fuse element is smaller than said fuse link.

66. The surge protection device according to claim 65, wherein said main fuse element comprises a fuse trace.

67. The surge protection device according to claim 65, wherein main fuse element comprises a thermal fuse spring.

68. The surge protection device according to claim 67, wherein a fuse trace is provided on said substrate between a finger of said thermal fuse spring and said transient suppressing element, a first end of said fuse trace being electrically connected to said bypass link and said finger when said finger is attached to said substrate and a second end of said fuse trace being electrically connected to said transient suppressing element.

69. The surge protection device according to claim 65, wherein said bypass link also includes a second transient suppressing element connected in series with said fuse link.

70. The surge protection device according to claim 69, wherein said second transient suppressing element is an MOV.

71. The surge protection device according to claim 69, wherein said second transient suppressing element is an SAD.

72. The surge protection device according to claim 65, wherein said bypass link also includes a capacitor connected in series with said fuse link.

73. The surge protection device according to claim 65, wherein said transient suppressing element is an MOV.

74. The surge protection device according to claim 65, wherein said transient suppressing element is an SAD.

75. The surge protection device according to claim 65, wherein an impedance of said main fuse element is smaller than an impedance of said fuse link.

76. The surge protection device according to claim 65, wherein an rms fault current rating of said main fuse element is smaller than an rms fault current rating of said fuse link.

77. The surge protection device according to claim 65, wherein said fuse link has a length that is greater than a length of said main fuse element.

78. The surge protection device according to claim 70, wherein said MOV is a low-clamping MOV.
